(19) United States
(12) Patent Application Publication
(10) Pub. No.: US 2010/0114354 A1
(43) Pub. Date: May 6, 2010

(54) METHOD FOR ESTIMATING IMMEASURABLE PROCESS VARIABLES DURING A SERIES OF DISCRETE PROCESS CYCLES

(75) Inventor: Cheol Lee, Birmingham, MI (US)

Correspondence Address: HARNESS, DICKEY & PIERCE, P.L.C., P.O. BOX 828, BLOOMFIELD HILLS, MI, 48303, US

(73) Assignee: The Regents of The University of Michigan, Ann Arbor, MI (US)

(21) Appl. No.: 12/613,994

(22) Filed: Nov. 6, 2009

Related U.S. Application Data
(60) Provisional application No. 61/111,817, filed on Nov. 6, 2008.

(51) Int. Cl. G05B 13/04

(52) U.S. Cl. 700/103; 700/164; 700/173

(57) ABSTRACT

A method for estimating a process variable associated with a series of operations of a manufacturing process includes deriving a model that represents a given operation of the manufacturing process. The operation has first, second, and third process variables associated therewith. The model includes the first, second, and third process variables. Variations in the first and second process variables during each of the operations are substantially immeasurable. The method further includes measuring the first process variable after a first one of the operations and measuring the third process variable during a second one of the operations using a sensing device. The method further includes estimating at least one of the first and second process variables during the second one of the operations using the measured first process variable, the measured third process variable, and the model. Additionally, the method includes controlling the second operation based on the at least one of the first and second estimated process variables.

### CROSS-REFERENCE TO RELATED APPLICATION

This application claims the benefit of U.S. Provisional Application No. 61/111,817 filed on Nov. 6, 2008. The disclosure of the above application is incorporated herein by reference in its entirety.

### FIELD

The present disclosure relates to systems and methods for estimating a process variable associated with a series of operations of a manufacturing process.

### BACKGROUND

Most industry processes for producing multiple parts of identical design and specifications involve repeating similar or identical process cycles in series. Batch processing for biochemical, semiconductor, and materials industries as well as traditional manufacturing operations including machining processes belong to this category. From a series of process cycles, two streams of data can be obtained. For instance, in the machining process, various sensors are used for in-process measurement of process variables such as powers, forces, and vibration. In contrast, the qualities of machined parts such as the surface finish and the tool conditions can be measured only by the post-process inspection in most applications. Despite recent progress, the real-time measurement of the condition of a grinding wheel is still a very challenging task. Active research is taking place for the development of sensors for in-process measurement of part qualities such as the residual stress and surface finish. However, their industry-wide acceptance has not yet been realized.

Conventional approaches to monitoring and controlling a series of process cycles tend to rely on only one out of the two data streams for this purpose. Existing estimation schemes for estimating part qualities and tool conditions in real-time for the machining process have focused only on analyzing sensor signals while overlooking the significance of post-process data flow in batch production. The systems and methods of the present disclosure improve observability by supplementing in-process sensor signals with post-process measurement of the part quality and tool condition from previous cycles. Accordingly, the systems and methods of the present disclosure utilize the post-process measurement data to improve the estimation performance of process cycles.

This section provides background information related to the present disclosure which is not necessarily prior art.

### SUMMARY

A method for estimating a process variable associated with a series of operations of a manufacturing process comprises deriving a model that represents a given operation of the manufacturing process. The operation has first, second, and third process variables associated therewith. The model includes the first, second, and third process variables. Variations in the first and second process variables during each of the operations are substantially immeasurable. The method further comprises measuring the first process variable after a first one of the operations and measuring the third process variable during a second one of the operations using a sensing device. The method further comprises estimating at least one of the first and second process variables during the second one of the operations using the measured first process variable, the measured third process variable, and the model. Additionally, the method comprises controlling the second operation based on the at least one of the first and second estimated process variables.

### BRIEF DESCRIPTION OF DRAWINGS

The present disclosure will become more fully understood from the detailed description and the accompanying drawings.

FIG. 1 illustrates a batch production of N parts that are processed in series on a grinding machine.

FIG. 2 is a functional block diagram of a manufacturing system according to the present disclosure.

FIG. 3 is a functional block diagram of a machine control module according to the present disclosure.

FIG. 4 illustrates a method for estimating a process variable associated with a series of operations of a manufacturing process according to the present disclosure.

FIG. 5 is a schematic of a cylindrical grinding process.

FIG. 6 illustrates a comparison of estimation results based on two measurement settings with which the observability was tested.

FIG. 7 illustrates performance of the proposed scheme in estimating R₀ as well as in predicting the surface roughness at the end of each grinding cycle.

FIG. 8 illustrates the overall schematics of the estimation algorithm.

FIG. 9 presents the results of estimating state variables V_{w}′ and v along with model parameter s₀ based on two measurement settings with experimental data from the first batch.

FIG. 10 shows the results of estimation and prediction for the surface roughness with experimental data from the first batch.

FIG. 11 shows results of estimation for the wheel diameter with experimental data from the first batch.

FIG. 12 shows estimation of V_{w}′, s₀, and v based on two measurement settings with experimental data from the second batch.

FIG. 13 shows results of estimation and prediction for the surface roughness with experimental data from the second batch.

FIG. 14 shows results of estimation for the wheel diameter with experimental data from the second batch.

FIG. 15 shows estimation of V_{W}′, s₀, and v with experimental data from a mix of different grinding cycles.

FIG. 16 shows results of estimation and prediction for the surface roughness with experimental data from a mix of different grinding cycles.

FIG. 17 shows grinding power P versus parameter τvₛv obtained from step responses of P.

FIG. 18 shows Parameter P/(Kₛd_{w}v) versus accumulated metal removal V_{w}′ from step responses of P.

FIG. 19 shows surface roughness versus equivalent chip thickness immediately after wheel dressing.

FIG. 20 shows wheel profiles for different values of equivalent chip thickness.

FIG. 21 shows change of G-ratio with varying equivalent chip thickness.

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical OR. It should be understood that steps within a method may be executed in different order without altering the principles of the present disclosure.

Batch production is commonly employed in industry to manufacture a group of parts or products with identical design and specifications. The start of a new batch is marked by the launch of a new design, tool change, or arrival of a new lot from suppliers or preceding processes. From a control point of view, the start of a new batch normally coincides with significant changes in the process dynamics, and hence the states and model parameters are updated when a new batch starts.

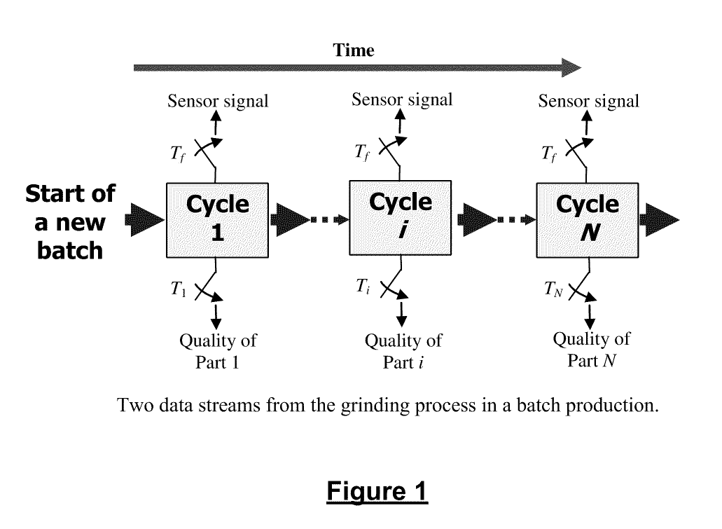

FIG. 1 shows a schematic of batch production when N parts are processed in series on a grinding machine. Many machine tools in modern industry are equipped with various sensors for monitoring process variables such as the grinding power, which are generally sampled at a constant frequency. In contrast, the quality of each part is usually only measured at a post-process inspection after its grinding cycle is completed. Ignoring the idle time between two consecutive grinding cycles, a series of grinding operations can be viewed as a continuous process with two output streams sampled at two distinct intervals. In the present disclosure, the sampling time of the sensor signal (T_{f}) is set constant, and that of the part quality is Tᵢ(>T_{f}), which corresponds to the cycle time of the ith grinding cycle, as shown in FIG. 1. While the following description is provided with reference to a grinding operation, it is readily understood that the estimation techniques are applicable to other machining processes as well as other types of discrete processes.

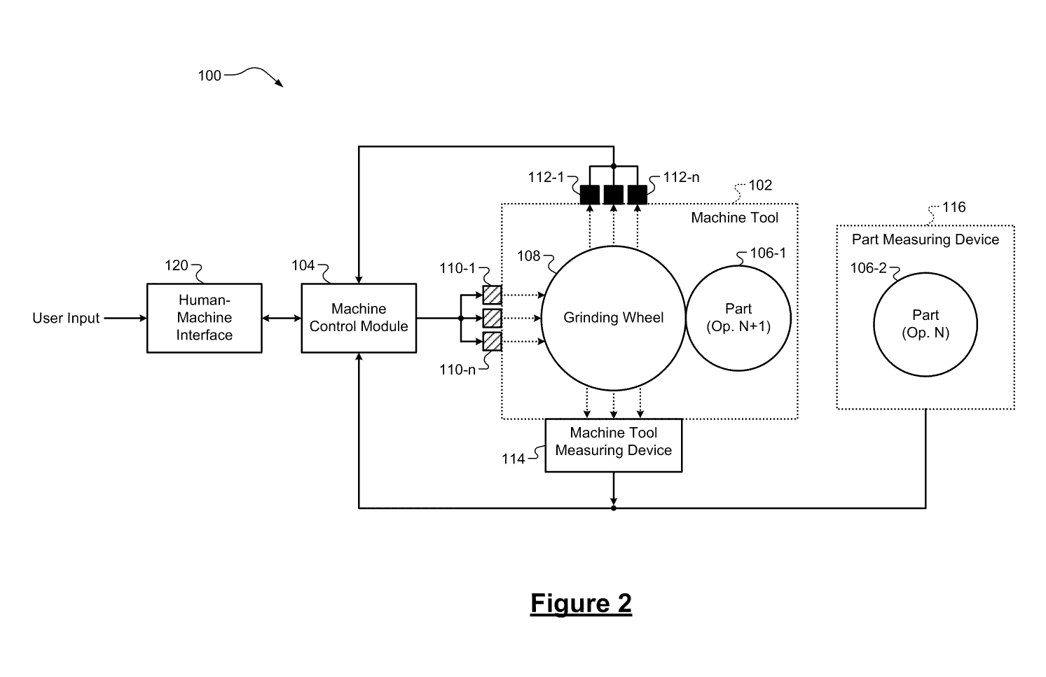

Referring now to FIG. 2, a manufacturing system 100 includes a machine tool 102 and a machine control module 104. The machine control module 104 actuates the machine tool 102 to perform an operation on parts 106-1 and 106-2 (collectively “parts 106”) during a manufacturing process. The machine tool 102 may include a grinding wheel 108. Accordingly, the machine tool 102 may be a grinding machine tool (e.g., a plunge grinder). While the machine tool 102 is described as a grinding machine tool that performs a grinding operation, the systems and methods of the present disclosure may be applicable to other machine tools that perform other operations. For example, the systems and methods may be applicable to a milling machine that performs milling operations, a drilling machine that performs drilling operations, and/or a lathe that performs a lathing operation. Additionally, the systems and methods of the present disclosure may be applicable to other tools and equipment that perform other process that do not include machining operations. For example, the systems and methods of the present disclosure may be applicable to batch processing for biochemical, semiconductor, and materials processes.

The machine control module 104 controls one or more actuators 110-1, . . . , and 110-n (collectively “actuators 110”) of the machine tool 102 to perform various operations on the parts 106. For example, the machine control module 104 may control the actuators 110 to control a rotational speed of the grinding wheel 108, an infeed rate of the grinding wheel 108, etc.

As used herein, the term module may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

One or more sensors 112-1, . . . , and 112-n (collectively “sensors 112”) of the machine tool 102 measure process variables associated with the manufacturing process. More specifically, the sensors 112 measure process variables associated with the machine tool 102 while the machine tool 102 is performing an operation. Process variables that may be measured by the sensors 112 during operation of the machine tool are referred to hereinafter as “measurable process variables.” For example, measurable process variables associated with the machine tool 102 may include the grinding power, a reduction in the size of the part 106, etc. The machine control module 104 may control the machine tool 102 based on feedback signals received from the sensors 112. Accordingly, the machine control module 104 may control the rotational speed of the grinding wheel 108 and the infeed rate of the grinding wheel 108 based on the grinding power and the reduction in the size of the part 106.

Other processing variables associated with the manufacturing process may be substantially immeasurable during the operation of the machine tool 102. For example, measurements associated with the grinding wheel 108 and/or the part 106 during the grinding process may be substantially immeasurable. Process variables that are substantially immeasurable during operation of the machine tool 102 are referred to hereinafter as “immeasurable process variables.” For example, immeasurable process variables may include a condition of the grinding wheel 108 (e.g., a diameter of the grinding wheel 108), a residual stress associated with the part 106, a roundness of the part 106, and a surface finish of the part 106.

Immeasurable process variables may be measured after operation of the machine tool 102. The machine control module 104 may control the machine tool 102 during subsequent operations based on immeasurable process variables which were measured after previous operations. Accordingly, the machine control module 104 may control a grinding operation based on process variables measured during the grinding operation using feedback from the sensors 112 and immeasurable process variables which were measured prior to the current operation.

A machine tool measuring device 114 measures immeasurable process variables associated with the machine tool 102 after a machining operation. In other words, after a grinding operation is complete, the machine tool measuring device 114 may measure process variables associated with the machine tool 102 that were substantially immeasurable during the previous grinding operation. For example, the machine tool measuring device 114 may measure the condition of the grinding wheel 108 (e.g., the diameter of the grinding wheel 108). The measurements taken by the machine tool measuring device 114 are fed back to the machine control module 104. Accordingly, the machine control module 104 may actuate the machine tool 102 during subsequent operations based on measurements of the machine tool 102 taken after previous operations.

A part measuring device 116 measures the immeasurable process variables associated with parts 106 machined by the machine tool 102. In other words, after a grinding operation is complete, the part measuring device 116 may measure process variables associated with the part 106 that the machine tool 102 produced that were substantially immeasurable during the grinding operation. For example, the part measuring device 116 may measure the residual stress associated with the part 106, the roundness of the part 106, and the surface finish of the part 106. The measurements taken by the part measuring device 116 are fed back to the machine control module 104. Accordingly, the machine control module 104 may actuate the machine tool 102 during subsequent operations based on measurements of the parts 106 taken after previous operations. In FIG. 2, a part 106-2 produced by a previous operation (operation N) is measured by the part measuring device 116. The measurements associated with the part 106-2 produced by operation N are fed back to the machine control module 104. The machine control module 104 then controls the machine tool 102 to perform a subsequent operation (operation N+1) on a subsequent part 106-1 based on the measurements associated with the part 106-2 produced by operation N.

The manufacturing system 100 may include a human-machine interface (HMI) 120 that receives user input from a human user of the machine tool 102. The machine control module 104 may control the machine tool 102 based on the user input. The HMI 120 may also display information associated with operation of the machine tool 102 to the user. In some implementations, the user of the machine tool 102 may measure the immeasurable process variables associated with the machine tool 102 and/or the parts 106 produced and input the measurements into the HMI 120. Accordingly, the machine control module 104 may control the machine tool 102 based on immeasurable process variables measured by the user.

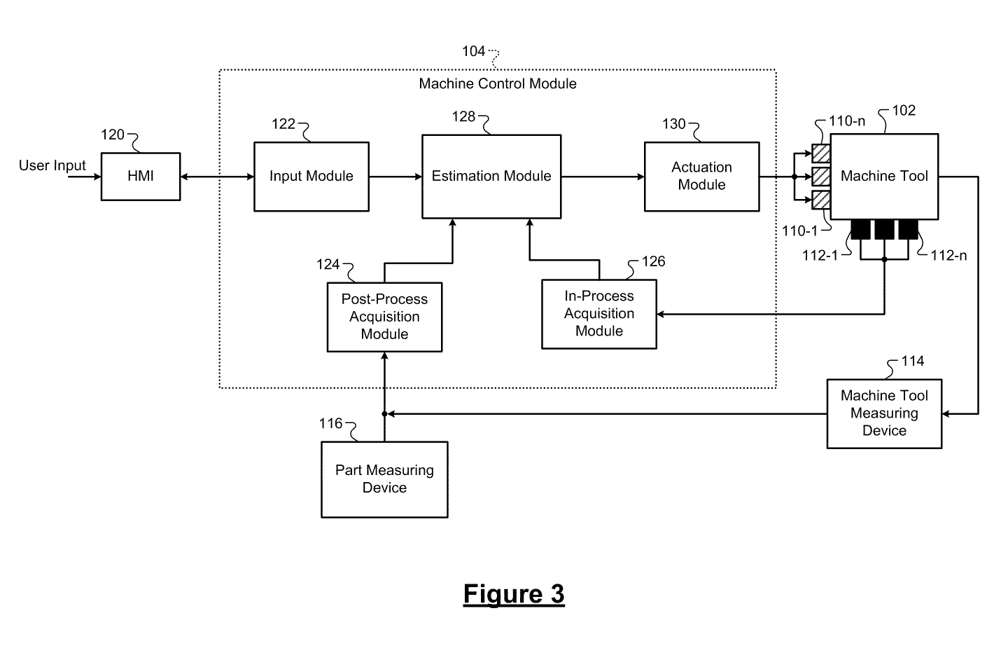

Referring now to FIG. 3, the machine control module 104 includes an input module 122, a post-process acquisition module 124, an in-process acquisition module 126, an estimation module 128, and an actuation module 130. The input module 122 receives user input from the HMI 120. The post-process acquisition module 124 receives data from the part measuring device 116 corresponding to measurements of parts 106 taken between operations of the machine tool 102. The post-process acquisition module 124 also receives data from the machine tool measuring device 114 corresponding to measurements of the machine tool 102 taken between operations of the machine tool 102. The post-process acquisition module 124 determines the immeasurable process variables based on the data received from the machine tool measuring device 114 and/or the part measuring device 116. For example, the post-process acquisition module 124 may determine the condition of the grinding wheel 108 (e.g., the diameter of the grinding wheel 108), the residual stress associated with the part 106, the roundness of the part 106, and the surface finish of the part 106 based on the data received from the machine tool measuring device 114 and/or the part measuring device 116.

The in-process acquisition module 126 receives signals from sensors 112 that measure process variables during operation of the machine tool 102. The in-process acquisition module 126 determines the measurable process variables based on the data received from the sensors 112 during operations of the machine tool 102. For example, the in-process acquisition module 126 may determine the grinding power and the reduction in the size of the part 106 based on data received from the sensors 112.

The estimation module 128 includes a model of the operations associated with the machine tool 102. For example, the estimation module 128 may include a state-space model representation of the operations (e.g., grinding operations) associated with the machine tool 102. The model includes the measurable and immeasurable process variables. The model is described hereinafter in further detail. The estimation module 128 may implement an estimation scheme (e.g., an estimation algorithm) to determine the immeasurable process variables during operations of the machine tool 102. For example, the estimation module 128 may implement an estimation scheme based on extended Kalman filters. The estimation scheme is described hereinafter in further detail.

In some implementations, the estimation module 128 includes a model that models variations in parameters of the machine tool 102 and/or the parts 106 between operations. For example, the model may include one or more noise terms that model the variations. The model that includes the noise terms is described hereinafter in further detail. A filter algorithm (e.g., a Kalman filter) may be derived based on the model that models variations between operations.

Variations in parameters of the machine tool 102 may include a variation in the radius of the grinding wheel 108 between the end of a prior operation and the beginning of a subsequent operation (e.g., due to temperature changes). Other variations in parameters of the machine tool 102 may also include, for example, variations that affect the position of the part 106 held within the machine tool 102. The position of the part 106 may vary between operations due to tolerances of a chuck that holds the part 106 in the machine tool 102. A magnitude of the noise term may be based on an amount of expected variation of a parameter of the machine tool 102. For example, the magnitude of the noise term corresponding to a parameter of the machine tool 102 may be greater when the tolerances related to the parameter are wider.

Variations in parameters associated with the parts 106 between operations may be due to variations in material properties of the parts 106 between operations. Material properties that vary between operations may include a hardness of the part 106, strength of the part 106, a ductility of the part 106, and a location and amount of imperfections in the part 106. Additionally, variations in conditions of the parts 106 between operations may be due to a difference in initial sizes of the parts 106.

The model may also account for variations in model parameters that represent physical properties of the manufacturing system 100. For example, model parameters related to mass of components of the machine tool 102 and/or the parts 106 may be modified by a noise term in order to represent variations of the physical properties of the manufacturing system 100.

The estimation module 128 may estimate the immeasurable process variables during an operation of the machine tool 102 based on the model, the measurable process variables measured during the operation, and the immeasurable process variables measured after a prior operation of the machine tool 102. The actuation module 130 controls the operation of the machine tool 102 during the operation based on the estimated immeasurable process variables. Accordingly, the actuation module 130 actuates the machine tool 102 during the operation based on the immeasurable process variables that were previously measured.

Manufacture of a first and second part in the manufacturing system 100 is now described. The machine control module 104 actuates the machine tool 102 to produce the first part during a first operation. The part measuring device 116 and/or the machine tool measuring device 114 measure the first part and or components of the machine tool 102, respectively, after the first operation to determine an immeasurable process variable. Additionally or alternatively, the user may input the immeasurable process variable based on measurements of the first part and or the machine tool 102 after the first operation. In some implementations, the machine control module 104 may modify gain parameters of the estimation algorithm using a noise term before a start of a second operation.

The second part is then loaded into the machine tool 102. The machine control module 104 actuates the machine tool 102 to perform the second operation on the second part. The sensors 112 of the machine tool 102 feed back data to the machine control module 104. The machine control module 104 may control the second operation based on the data fed back from the sensors 112 during the second operation. Additionally, the machine control module 104 controls the second operation based on the immeasurable process variables that were measured after the first operation. The machine control module 104 estimates the immeasurable process variables during the second operation using the measured process variables (i.e., data fed back from the sensors 112) during the second operation, the immeasurable process variables measured after the first operation, and the model. The machine control module 104 controls the machine tool 102 during the second operation based on the estimated immeasurable process variables.

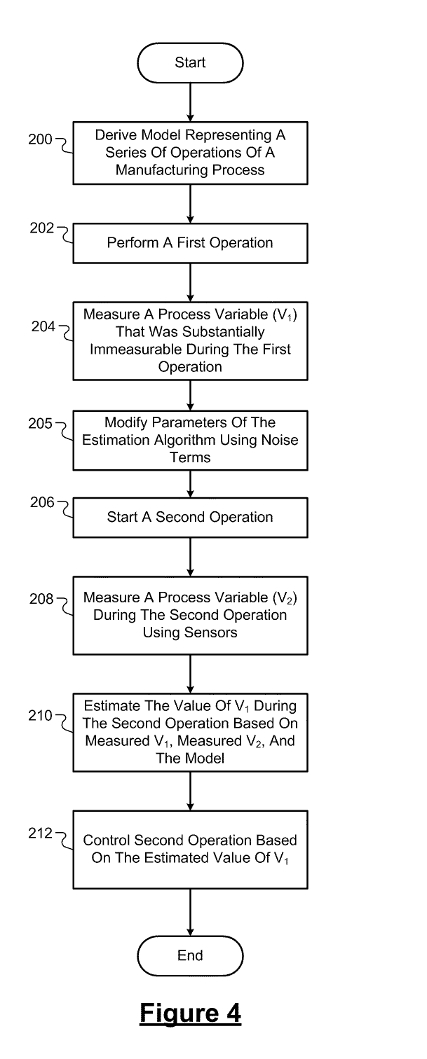

Referring now to FIG. 4, a method for estimating a process variable associated with a series of operations of a manufacturing process starts at 200. At 200, a model is derived that represents a series of operations of a manufacturing process. At 202, the machine tool 102 performs a first operation on a first part. At 204, the machine tool measuring device 114 and/or the part measuring device 116 measure a process variable (V₁) that was substantially immeasurable during the first operation. At 205, the estimation module 128 may modify parameters of the estimation algorithm using noise terms. At 206, the machine tool 102 starts a second operation on a second part. At 208, the in-process acquisition module 126 determines a process variable (V₂) during the second operation based on feedback from sensors 112. At 210, the estimation module 128 estimates the value of V₁ during the second operation based on the measured V₁ at 204, the measured V₂ at 208, and the model. At 212, the machine control module 104 controls the machine tool 102 during the second operation based on the estimated value of V₁.

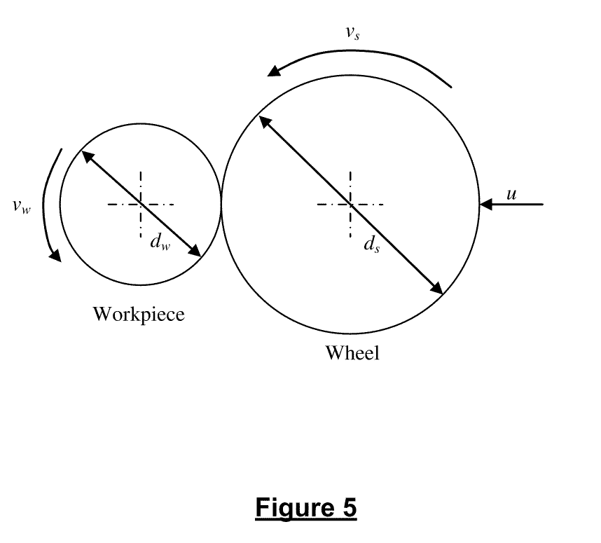

A derivation of a state-space model from existing analytical models of the cylindrical plunge grinding process is briefly described herein. FIG. 5 shows a schematic of a cylindrical grinding process, in which a rotating cylindrical work-piece with a nominal diameter of d_{w} and a surface velocity of v_{w} is ground by a rotating grinding wheel with a nominal diameter of dₛ and a surface velocity of vₛ. The grinding wheel is fed into the work-piece at a command infeed rate, u.

Three dynamic relationships may be included for the cylindrical grinding process in an analytical model. It may be assumed that the grinding is carried out in a chatter-free region. The first relationship is the dynamic delay of the actual infeed rate, v (mm/s), in response to the command infeed rate, u (mm/s), due to the mechanical stiffness and sharpness of the wheel surface, which is frequently modeled as a first-order system:

\dot{v}=(u−v)/τ (1)

where τ(s) is the time constant whose value is dependent on the machine-wheel-workpiece stiffness and the sharpness of the wheel. The sharpness of the wheel decreases with the accumulated amount of material removed after a tool change, V_{w}′(mm³/mm), due to attrition of the grits. The accumulated metal removal, by its definition, is related to infeed rate v by another first-order differential equation:

\dot{V}_{w}′=πd_{w}v (2)

On the other hand, the radial wheel wear—which involves a progressive reduction in the diameter of the grinding wheel—may be obtained by manipulation of an analytical model represented by the following equation:

$${\dot{d}}_{s} = - \frac{2 {π}^{g} {d}_{w}^{1 + g}}{{d}_{{s}_{0}} {G}_{1}} {v}_{s}^{- g} {v}^{1 + g} \qquad ( 3 )$$

where dₛ_{₀} is the initial wheel diameter (mm), and G₁ and g are model parameters.

Based on (1)-(3), three state variables are defined to describe the dynamic relationships in the grinding process using the following state equation:

\dot{x}=f(x,u)+η(t) (4)

where x=(x₁, x₂, x₃)^{T}=(V_{w}′, v, dₛ)^{T}ε [symbol] ³u=(u₁, u₂)^{T}=(u, vₛ)^{T}ε [symbol] ²and η(t) ε [symbol] ³ are the state vector, input vector, and process noise, respectively, and f is a nonlinear vector function.

Existing models for the outputs from a grinding process can be converted into static functions of the state and input variables. Appendix A provides the output equations derived for various outputs such as the grinding power, roundness, part-size reduction, surface roughness, and wheel diameter. The output equation of the state-space model can be written as

y=h(x,u)+ξ(t) (5)

where y is the output vector, ξ(t) is the measurement noise, and h is a nonlinear vector function. According to the two distinct sampling intervals described above, the output vector can be divided into a fast-measurement vector, y_{f}, and a slow-measurement vector, yₛ (i.e., y=[y_{f}; yₛ]). The components of y_{f} are real-time sensor signals of the grinding power and part-size reduction, whereas those of yₛ correspond to the roundness, surface roughness, and wheel diameter, which are measured through post-process inspection.

As in many adaptive filtering schemes, the model parameters are modeled as the random walk processes and then appended to the state vector to form an augmented system:

\dot{X}=F(X,u)+η₁(t) (6)

where X equals [x; θ]; η₁(t) corresponds to [η(t); ν(t)], with η(t) and ν(t) being white Gaussian noises; and θ is the vector of model parameters whose dynamics is given as \dot{θ}=ν(t). The output equation can be represented using the augmented state vector:

y=H(X,u)+ξ(t) (7)

The augmented system in (6) is represented in the discrete-time domain as follows:

X(i, j+1)=F_{d}[X(i, j)]+η₁(i, j) (8)

where X(i, j) denotes the state vectors at the jth sampling instance of the ith grinding cycle, i (=1, 2, . . . , N) denotes the cycle number, η₁(i, j) is the white Gaussian noise sequence (whose covariance is Q) and F_{d} (X,u)=X+T_{f}F(X,u). Assuming the cycle time of the ith cycle, Tᵢ, is given by nᵢ (an integer) times the sampling time T_{f} (i.e., Tᵢ=nᵢT_{f}), the sampling index j starts from 0 and increases up to nᵢ−1 in (8).

A representation of output sampling from a series of grinding cycles is given in the discrete time domain as follows:

Within the ith cycle or when jε{0, 1 nᵢ−1}

$$\begin{matrix}y ( i , j ) = {y}_{f} \\ = {H}_{f} [ X ( i , j ) , u ( i , j ) ] + {ξ}_{f} ( i , j )\end{matrix} \qquad ( 9 )$$

where H_{f} is composed of the elements in H corresponding to the sensor output vector, y_{f}, and ξ_{f}(i, j) is the measurement noise (with covariance R_{f}) in the sensor output.

At the end of the ith cycle or when i=nᵢ

y(i, nᵢ)=H[X(i, nᵢ), u(i, nᵢ)]+ξ(i,nᵢ) (10)

where ξ(i, nᵢ) is the measurement noise (with covariance R) in the whole output including the sensor output. Both the slow and fast measurements are sampled at the end of the ith cycle.

The observability was tested by linearizing the augmented model in (6) and (7) around more than 10 operating points that were randomly selected from a typical trajectory. Table I summarizes the observability test for two estimation tasks, each with two measurement settings. Among the available measurements, the grinding power, P and part-size reduction, D_{w}, are assumed to be measured with in-process sensors, whereas the wheel diameter, dₛ and surface roughness, Rₐ would be obtained via postprocess inspection.

TABLE I
OBSERVABILITY UNDER VARIOUS CONDITIONS

| | Variables to | | Measurement | | |
|---|---|---|---|---|---|
| | be estimated | | setting | | |
| | State | Model | In-process | Postprocess | |
| Case | variables | parameters | sensors | inspection | Observability |
| 1 | x₁, x₂, x₃ | — | P, D_{w} | — | Deficient |
| | | | P | dₛ | Full |
| 2 | x₁, x₂, x₃ | R₀ | P, D_{w} | dₛ | Deficient |
| | | | P | dₛ, Rₐ | Full |

The first task in Table I is to estimate the state variables while excluding any model parameters (i.e., X=x). It can be seen from the first measurement setting of the task that the system is not observable when both P and D_{w} are measured. The estimation becomes feasible when dₛ is directly measured in addition to P, as shown for the second setting. The second case in Table I involves estimating the state variables in addition to a model parameter in the surface roughness model, R₀; that is, X=[x; R₀]. The output equation in Appendix A for Rₐ is repeated here for reference:

$${R}_{a} = [ {R}_{g} + ( {R}_{0} - {R}_{g} ) exp ( - \frac{{x}_{1}}{{V}_{0}^{′}} ) ] {( \frac{π {d}_{w} {x}_{2}}{{u}_{2}} )}^{γ} \qquad ( 11 )$$

It is evident from Table I that estimation of R₀ requires a direct measurement of Rₐ. In fact, most parameters in the output equations related to part quality (e.g., surface roughness and roundness) can only be made observable through direct feedback, which may not be available during a cycle run. The observability analysis in this section provides a strong motivation for involving postprocess measurement data in the estimation of model parameters, as well as full observability of state variables.

An exemplary estimation scheme is based on extended Kalman filters (EKFs). An EKF operation includes a priori and a posteriori updates at each sampling instant. The a priori update is made through a discrete-time simulation of the model, whereas the a posteriori update involves comparing the a priori estimate with the actual measurement. In the following descriptions, a vector with a hat (‘̂’) denotes an estimate after an a posteriori update, whereas one with both a hat and a minus sign (‘⁻’) denotes an a priori estimate. Other types of estimation schemes are also contemplated by this disclosure.

During a cycle run, X is estimated using an EKF based on measurement of y_{f}, while yₛ is estimated by substituting the estimate, \hat{X}, the known input, u, and a zero noise, ξ=0, into the output equation. Another EKF operation is applied at the end of each grinding cycle based on both the sensor output and the post-process measurement, thereby improving the robustness of the overall estimation. The multi-rate EKF operations used in this disclosure are described in more detail in Appendix B.

At the beginning of a cycle, the actual infeed rate, v (=x₂), starts from 0 regardless of its last estimate in the preceding cycle, i.e. \hat{x}₂⁻(i,0)=0. On the other hand, the accumulated removal, V_{w}′ (=x₁), by its definition, as well as the wheel diameter, dₛ (=x₃), should be continuous across cycles. Hence, their estimate should be also continuous:

\hat{x}_{1,3}⁻(i,0)=\hat{x}_{1,3}(i−1,n₁₋₁) (12)

where x_{1,3} corresponds to either V_{w}′ or dₛ.

In contrast, model parameter 0 may not be strictly continuous between any two cycles in a series due to inherent variations in the grinding process. Cycle-to-cycle variations in batch production may be modeled as random step changes of the process between cycles. Assuming that the step variations are purely random, the estimate of the process parameter at the beginning of a cycle is initialized to its last estimate in the previous cycle as follows:

\hat{θ}(i,0)=\hat{θ}(i−1, nᵢ₋₁) (13)

Simulations were performed for the two estimation tasks whose observability was tested. The first case involved estimation of state variables, whereas the second case study involved simultaneous state and parameter estimation for compensating the model-process mismatch.

The simulated process data were generated using (8)-(10) when T_{f}=0.02 s from 10 consecutive cycles based on the nominal values of the model parameters listed in Table II, which were obtained from various studies that have involved the grinding of heat-treated steels with aluminum oxide wheels. Although not required by the proposed scheme, an identical set of grinding conditions was applied to each of the 10 cycles. Specifically, the wheel speed, vₛ, and the work speed, v_{w}, were fixed at 37 m/s and 0.533 m/s, respectively, whereas the command infeed rate, u, was scheduled such that plunge grinding is performed in three distinct stages of roughing, finishing, and spark-out within 17 s (roughing: u=0.0254 mm/s for 0≦t<9.5 s, finishing: u=0.0020 mm/s for 9.5≦t<13.3 s, spark-out: u=0 mm/s for 13.3≦t≦17 s). Appropriate process and measurement noises as listed in Table III were added during the simulation according to (8)-(10).

TABLE II
NOMINAL VALUES OF MODEL PARAMETERS IN THE
SIMULATION

| d_{w} | dₛ₀ | | | Kₛ | | |
|---|---|---|---|---|---|---|
| (mm) | (mm) | s₀ | s₁ | (N/mm) | δ | γ |
| 70 | 50 | 49.6 | 0.08 | 2380 | 1 | 0.2 |

| | | V₀′ | | | | |
|---|---|---|---|---|---|---|
| R_{g} | R₀ | (mm³/mm) | rₘ | r₀ | G₁ | G |
| 0.7 | 3 | 300 | 2.4 | 1 | 13 | 0.9 |

TABLE III
PROCESS AND MEASUREMENT NOISES FOR THE SIMULATION

| | | | Measurement | | |
|---|---|---|---|---|---|
| | | | setting | | |
| | | | In- | | |
| | Augmented | | process | Postprocess | |
| Case | state vector, X | Process noise, Q | sensors | inspection | Measurement noise, R |
| A | (x₁, x₂, x₃)^{T} | 4 × diag[0.01 10⁻⁹ 10⁻⁹] | P, D_{w} | — | diag[10000 0.0001] |
| | | | P | dₛ | diag[10000 10⁻⁶] |
| B | (x₁, x₂, x₃, R₀)^{T} | 4 × diag[0.01 10⁻¹¹ 10⁻⁹ 10⁻⁹] | P, D_{w} | dₛ | diag[10000 0.0001 10⁻⁶] |
| | | | P | dₛ, Rₐ | diag[10000 10⁻⁶ 0.0001] |

A real-time knowledge of the wheel diameter allows for a tight control of the work-piece dimension, but in-process sensing of the wheel diameter is difficult due to the high rotation speed of the grinding wheel and its abrasive action. It is shown above that the wheel diameter cannot be estimated based on measurement of either the grinding power, P, or the part-size reduction, D_{w}. The main aim in this case study was to estimate the wheel diameter in real time during a cycle run through simulation of the process model based on input variables and estimates of other state variables, while intermittently correcting the estimate based on post-process measurement of its actual value.

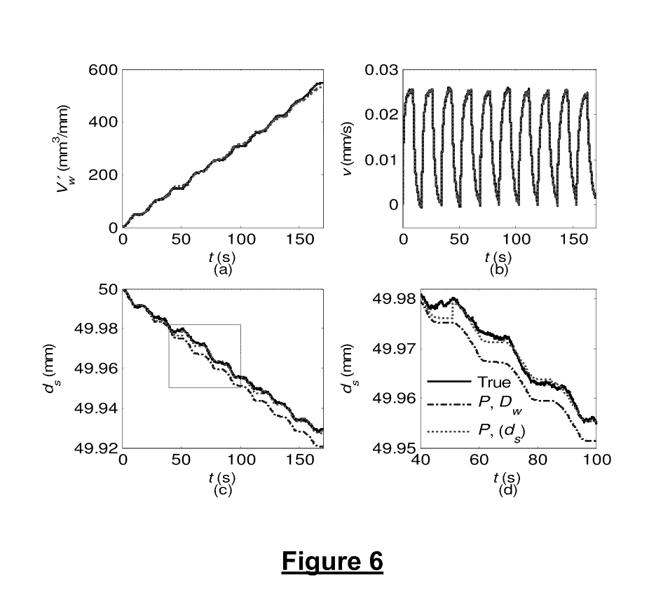

FIG. 6 compares the estimation results based on the two measurement settings with which the observability was tested as Case 1 in Table I. The initial error covariance is denoted as P₀ along with Q denoting the process noise covariance for the extended Kalman filter. In FIG. 6, P₀=diag[10 10⁻⁷ 10⁻⁶] and Q=4×diag[0.01 10⁻⁹ 10⁻⁹]. The parentheses around dₛ in the key denote that it is sampled through a post-process measurement. In FIG. 6(a) V′_{w}=x₁, in FIG. 6(b) v=x₂, in FIG. 6(c) dₛ=x₃. FIG. 6(d) is a magnified view of the plot within the rectangle in FIG. 6(c).

In the present study, covariance matrices of process noise and measurement noise for the Kalman filter were initially determined according to the simulation conditions listed in Table III, and tuned by trial-and-errors if necessary. In FIG. 6, the solid lines are the true values of the state variables, while the other two lines show estimates of the state variables based on the two measurement settings over a series of 10 grinding cycles. Note that, for simplicity, FIG. 6 does not show any idle times between cycles associated with unloading and loading of parts.

The first measurement setting corresponds to those of existing observers in studies based solely on in-process sensors. FIG. 6 shows that although the first two state variables were tracked well under both measurement settings, the estimated wheel diameter of the first measurement setting exhibits an offset from the true value. In contrast, correcting the estimate of the wheel diameter in the second measurement setting at the end of each grinding cycle leads to a better overall estimation.

This case was a state-parameter estimation problem with a model-process mismatch in the output equation for the surface roughness. It is demonstrated that intermittent post-process measurement of the part quality can reduce the model-process mismatch due to process variations as well as predict the part quality in real time.

In addition to the continuous drift described as the random walk process, both batch-to-batch variation and cycle-to-cycle variations were simulated for parameter R₀ in (11). A batch-to-batch variation was introduced by increasing Rₒ by 20% from its value listed in Table II when the first cycle started, whereas a cycle-to-cycle variation was described as another random walk process by adding a white Gaussian noise with a covariance of 0.0001 to R₀ at the beginning of every cycle.

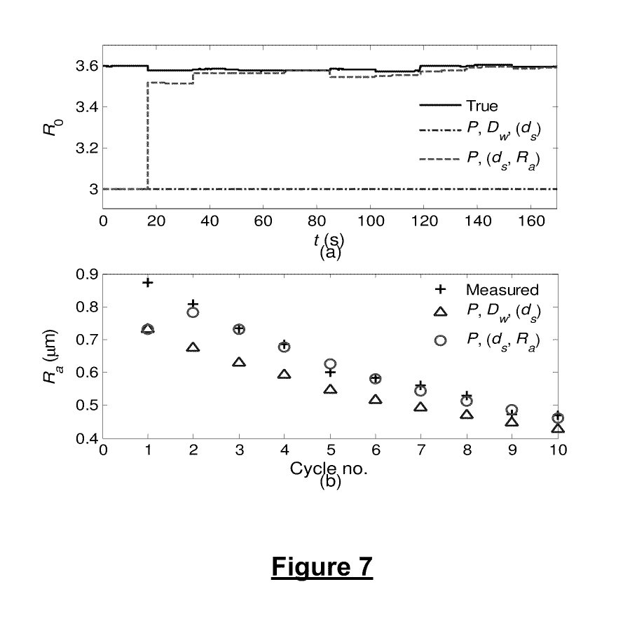

The estimation algorithm was applied to the simulated measurement data generated according to the above procedure, and input data. The performance of the proposed scheme in estimating Rₒ as well as in predicting the surface roughness at the end of each grinding cycle is shown in FIG. 7. In FIG. 7, the results of estimation are as follows: Pₒ=diag[0.1 10⁻¹¹ 10⁻⁶ 0.01] and Q=1.6×diag[10⁻⁵ 10⁻¹⁴ 10⁻¹² 10⁻⁷]. FIG. 7(a) shows model parameter R₀. FIG. 7(b) shows a comparison of Rₐ and its a priori estimate, \hat{R}ₐ⁻, at the end of each cycle.

The true R₀ is shown as a solid line in FIG. 7(a), and the prediction in FIG. 7(b) refers to an a priori estimate of surface roughness at the end of each grinding cycle before an a posteriori update takes place based on measurement of the actual surface roughness. The measured surface roughness in FIG. 7(b) corresponds to that generated by simulation with a measurement error added according to (7).

Two measurement settings of Case 2 in Table I were considered in this case study. As expected from the results of observability test, R₀ in the output equation for the surface roughness cannot be estimated based on the first measurement setting. On the other hand, R₀ was updated at the end of each cycle with the second measurement setting as shown in FIG. 7(a), leading to a good agreement between the measured surface roughness and the prediction at the end of each cycle in FIG. 7(b).

The present disclosure has proposed a new control-oriented estimation scheme for a series of grinding cycles in the batch production of precision parts. Analysis has revealed that active feedback of the post-process measurement data allows new and effective observers to be developed, notably in cases where the grinding systems would be unobservable with existing in-process sensors. Although specific applications have been demonstrated for estimating problems in the grinding process, this disclosure has focused on introducing those involved in discrete machining in batches to the new concept of integrating all the incoming data flows, with the aim of improving process control. A similar approach could be considered for machining processes in general, as well as polishing and chemical mechanical planarization operations for the optics and semiconductor industries.

The systems and methods of the present disclosure may model variations in the machine tool 102 and/or the parts 106 that arise between discrete process cycles. The model that models the variations may include noise terms that represent the variations. The noise terms may be used to adjust corresponding parameters of the model at the end of a first operation. The model may then use the adjusted parameters during a second operation in order to compensate for the variations that arise between the first and second operations. The model that incorporates the noise term is described hereinafter in further detail.

Multi-rate noise characteristics of discrete process cycles in series may be represented in the state-space format, based on which the propagation of the error covariance between consecutive cycles is derived. A simulation is carried out to demonstrate the advantage of the proposed change to the estimation algorithm for systems under multi-rate noise.

A state-space representation in the discrete-time domain may assume the following general structure:

x_{i,k+1}=f(x_{i,k},u_{i,k})+η_{i,k} (14)

where i and k denote indices, x_{i,k}ε [symbol] ⁿu_{i,k}ε [symbol] ^{p} and η_{i,k}ε [symbol] ⁿ are the state vector, input vector, and within-cycle process noise, respectively, and f is a nonlinear vector function. Note that index i denotes the cycle number while k is the sampling index. The state-space equation may be derived from the known physics and prior observation of the process. The state variables in Eq. (14), therefore, will correspond to current and past values of physical parameters in the process unless they are mapped through state transformations. These physical parameters may include measurable or immeasurable process variables such as depth of cut, feed, feed rate, and so on in the case of machining processes. Furthermore, model parameters can be appended to the state vector if the process is deemed time-varying. The process noise, η_{i,k} is assumed to be zero-mean white Gaussian with covariance Q_{i,k}.

The state variables, thus defined, can be classified into two groups based on their characteristics between two cycles. Ignoring any disturbances between the two cycles, a continuous state variable such as the machine condition in the (i+1)th cycle would start from their last values of the ith cycle. Furthermore, if the cycle-to-cycle variation of the process is ignored, the model parameters appended to the augmented state vector will also vary continuously from cycle to cycle. In reality, any transition of the continuous state variables will be disturbed by cycle-to-cycle variations such as changes in raw stock properties and set-up errors. Let x_{i,k}^{c} denote the vector including all continuous state variables of x_{i,k}. Assuming the cycle-to-cycle disturbance is also white Gaussian, the following simple model for describing the transition of x_{i,k}^{c} between two consecutive cycles is proposed:

x_{i+1,0}=x_{i,n}_{ᵢ}^{c}+φᵢ (15)

where φᵢ is a noise term. For example, φᵢ may be a white Gaussian noise sequence.

In contrast, discontinuous state variables such as the feed rate (in the case of machining processes) and most of the operating parameters in the (i+1)th cycle will start from their initial conditions, regardless of their last values in the ith cycle. Let x_{i,k}^{d} denote the vector whose elements are discontinuous state variables of x_{i,k} where x_{i,k}=[x_{i,k}^{c};x_{i,k}^{d}]. Assuming another independent Gaussian noise between two consecutive cycles, the following model is proposed for x_{i,k}^{d}:

x_{i+1,0}=x₀^{d}+νᵢ (16)

where x₀^{d} is a constant vector representing the initial condition of the discontinuous state vector and νᵢ is a noise term. For example, νᵢ may be the white Gaussian noise sequence. In this study, Qᵢ denotes the covariance of [φᵢ; νᵢ]. It can be seen from Eqs. (14-16) that a series of process cycles can be modeled as a system of dual dynamics, i.e. within-cycle dynamics and cycle-to-cycle dynamics subject to the multi-rate noise.

The multi-rate estimation algorithm described above was based on extended Kalman filters (EKFs). An EKF operation at each sampling instance includes a priori and a posteriori updates. The a posteriori update refers to correction of state variables and error covariance P using the measurement whilst the a priori update is made based on the process model. The error covariance P at the beginning of a cycle continues from its last value of the previous cycle. This approach, however, falls short of properly addressing the cycle-to-cycle variation that can be observed at the beginning of each cycle. The propagation of error covariance between two consecutive cycles considering the cycle-to-cycle noise is derived below.

In the following descriptions, a vector with a hat (‘̂’) denotes an estimate after an a posteriori update, while one with both a hat and a minus sign (‘⁻’) denotes an a priori estimate. A priori update of state between two cycles takes place according to Eqs. (15) and (16) as follows:

$${\hat{x}}_{i + 1 , 0}^{-} = [ \begin{matrix}{\hat{x}}_{i , {n}_{i}}^{c} \\ {x}_{0}^{d}\end{matrix} ] \qquad ( 17 )$$

As with conventional extended Kalman filters, we assume estimation error \tilde{x}=x−\hat{x} is unbiased. It is desired to obtain:

P_{i-1,0}⁻=E└\tilde{x}_{i+1,0}⁻(\hat{x}_{i+1,0}⁻)^{T}┘ (18)

However, from Eqs. (15), (16) and (17),

$${\tilde{x}}_{i + 1 , 0}^{-} = [ \begin{matrix}{\tilde{x}}_{i , {n}_{i}}^{c} + {ϕ}_{i} \\ {υ}_{i}\end{matrix} ] \qquad ( 19 )$$

Here, [φᵢ; νᵢ] is the white Gaussian noise sequence with Qᵢ. Therefore, it can be shown after some manipulation that:

$${P}_{i + 1 , 0}^{-} = {Q}_{i} + [ \begin{matrix}{p}_{i , {n}_{i}}^{c} & 0 \\ 0 & 0\end{matrix} ] \qquad ( 20 )$$

where P_{i,n}_{ᵢ}^{c}=E└\tilde{x}_{i,n}_{ᵢ}^{c}(\tilde{x}_{i,n}_{ᵢ}^{c})^{T}┘ is a subset of the error covariance at the end of the previous cycle, corresponding to the continuous state vector, x^{c}.

With the conventional extended Kalman filter, the error covariance P often converges to a small value too soon resulting in sluggish response of estimates to measurements. Considering a series of discrete process cycles is subject to the periodic cycle-to-cycle noise, the premature convergence of P, unless prevented by the proposed step in Eq. (20), can degrade the tracking performance of the observer.

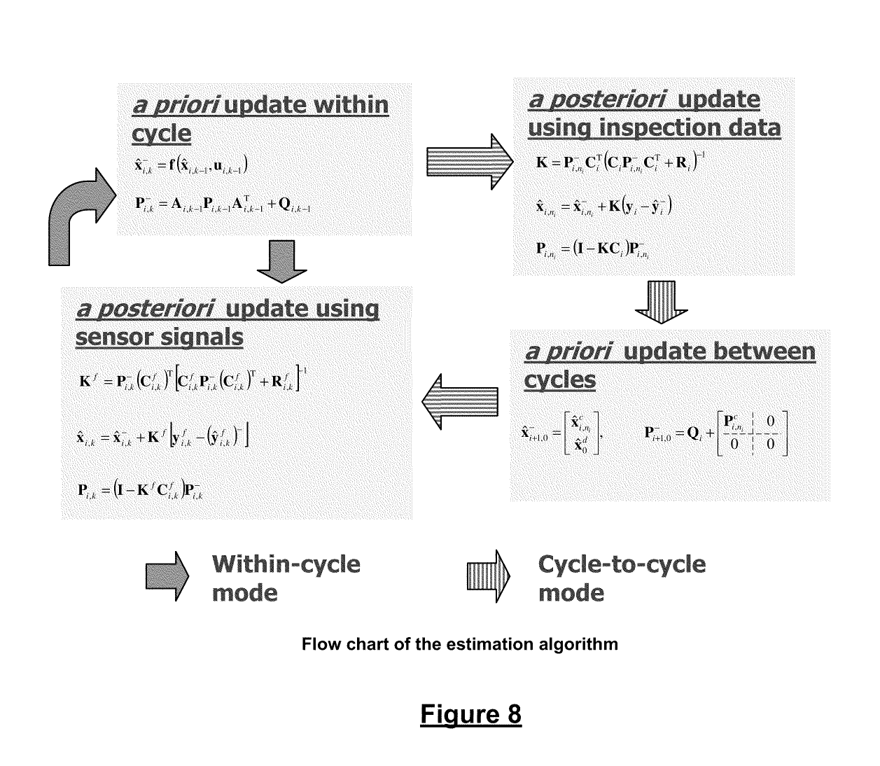

FIG. 8 shows the overall schematics of the estimation algorithm. In FIG. 8, A denotes the Jacobian matrix of f, C^{f} and C are the Jacobian matrices of h^{f} and h, respectively, and K^{f} and K are the Kalman gains for y^{f} and y, respectively. Within each cycle, an a priori update of the state vector takes place through a simulation of the process model whereas that of error covariance P is carried out after the model is linearized around the current state estimate. The a posteriori update is made in two different modes, depending on availability of the sensor output and postprocess inspection data, by comparing the a priori estimate of sensor output with the actual sensor signal. The linearized output equation is used for calculating the Kalman gains and the a posteriori update of error covariance P. When a new cycle starts, the a priori updates of state and error covariance P are made according to Eqs. (17) and (20).

Several parameters including covariances for the measurement noise, Rᵢ, within-cycle process noise, Q_{i,k}, cycle-to-cycle noise, Qᵢ, and initial error covariance P₀ may be specified with the proposed observer. Determining the covariance of measurement noise, Rᵢ, can be a straightforward task since the measurement accuracy is known in many applications. In contrast, the process noise covariances are rather difficult to obtain, as they can be time-varying in many processes. In this study, both process noise covariances and the initial error covariance were determined by trial-and-errors.

Although several systematic methods have been proposed in the literature for tuning of process noise covariances of extended Kalman filters (EKF's), achieving such goals by trial-and-error still seems to be a common practice. However, such ad-hoc methods can be very time-consuming and tedious. Since the proposed observer requires another covariance matrix for the cycle-to-cycle noise (Qᵢ), in addition to the covariances of conventional EKF's, to be specified, its tuning process can become even more laborious. Therefore, the following intuitive guidelines are suggested:
It is likely that the process will be subject to larger disturbances and noises when switching from one cycle to the next than between sampling instances during a cycle run. Therefore, the cycle-to-cycle noise covariance, Qᵢ, should be larger than the within-cycle process noise covariance, Q_{i,k}. For example, Qᵢ was chosen to be 10,000 times Q_{i,k} for all three batches of the validation experiment. A similar argument can be made with respect to the batch-to-batch versus cycle-to-cycle noises, i.e., a larger covariance matrix should be chosen for the batch-to-batch process noise. Since the initial error covariance of the first cycle in each batch, P₀, can represent the batch-to-batch process noise with any continuity between consecutive batches ignored, P₀ was chosen to be 4 times Qᵢ for all three batches of the observer experiment.
Increasing the process noise covariances of the observer led to quicker responses to measurement updates with increased sensitivities to measurement noises.

The developed multi-rate estimation scheme was implemented and experimentally validated for an actual cylindrical grinding process. The grinding was performed on a Supertec G20P-45CII cylindrical grinding machine. Grinding specimens were prepared by heat-treating 4140 steel rods with a nominal work diameter of 63.5 mm to Rockwell hardness C50. In this experimental study, aluminum oxide grinding wheels (32A60 KVBE) with a nominal diameter of 335 mm and a width of 38.1 mm were used. The width of the work-piece was 19.1 mm while the rotational speed of the wheel was fixed at 1800 rpm. A Mitutoyo SJ-201P surface roughness tester was used to measure the surface roughness over 4 mm in the direction normal to grinding with a cut-off length of 0.8 mm. The roughness value of each specimen represents an average of 9 independent measurements. Grinding powers were measured using a fast response PH-3A power cell from Load Controls and transferred to a computer through a data acquisition system at a sampling rate of 200 Hz. The amount of wheel wear was measured by scanning a replica of the wheel profile after each cycle using a Keyence LK-G10 laser triangulation sensor.

Process models for the cylindrical plunge grinding process were developed based on models and a series of experiments. The process models include three dynamic relationships in the grinding process and output equations for grinding power, surface roughness, wheel size, and part size reduction as listed below:

$$\begin{matrix}\dot{v} = ( u - v ) / τ & ( 21 ) \\ {\dot{V}}_{w}^{′} = π {d}_{w} v & ( 22 ) \\ {\dot{d}}_{s} = - \frac{2 {π}^{g} {d}_{w}^{1 + g}}{{d}_{{s}_{0}} {G}_{1}} {v}_{s}^{- g} {v}^{1 + g} & ( 23 ) \\ P = {K}_{s} ( {s}_{0} + {s}_{1} {V}_{w}^{′δ} ) {d}_{w} v \\ {R}_{a} = {R}_{0} + {{R}_{1} ( \frac{π {d}_{w} v}{{v}_{s}} )}^{γ} & ( 24 ) \\ {D}_{w} = \frac{2 {V}_{w}^{′}}{π {d}_{w}} MW & ( 25 )\end{matrix}$$

where v is the actual infeed rate (mm/s), u is the command infeed rate, τ is the time constant (s), V_{w}′ is the accumulated amount of metal removed from the workpiece after wheel dressing or reconditioning (mm³/mm), d_{w} is the nominal diameter of the workpiece (mm), dₛ is the wheel diameter (mm), dₛ_{ₒ} is the initial wheel diameter, vₛ is the wheel speed (m/s), P is the grinding power (W), Rₐ is the surface roughness (μm), D_{w} is the accumulated reduction in part diameter (mm), and G₁, g, s₀, s₁, δ, Kₛ, R₀, R₁, and γ are model parameters.

Nominal values of the model parameters in the above equations were determined by curve-fitting the experimental data. The nominal model parameters, thus obtained, are listed in Table IV. Refer to Appendix C for a detailed description of the model development.

TABLE IV
Nominal model parameters obtained from experiments

| | | | | | Kₛ | | | |
|---|---|---|---|---|---|---|---|---|
| G₁ | G | s₀ | s₁ | δ | N/mm | R₀ | R₁ | γ |
| 87.6 | 0.0908 | 1.03 | 0.00188 | 0.665 | 1894 | 0.478 | 9.38 | 0.776 |

The process models above were converted into a state-space format for observer designs. The state vector, thus obtained, includes three variables, i.e., the accumulated amount of metal removed from the workpiece after wheel dressing, V_{w}′, the wheel diameter, dₛ, and the actual infeed rate, v.

The proposed estimation scheme was tested on three batches of grinding cycles. Each of the first two batches consisted of 8 identical grinding cycles in series, emulating a typical batch production run, whereas the last batch had 10 varying cycles in series. Real-time sensing of grinding power and post-process measurement of surface roughness and part-size reduction were available with all three batches, while the radial wheel wear data were obtained only from the first two batches.

Simultaneous state-parameter estimation problems were formulated by appending model parameters to the original state vector. The model parameters were assumed to be random walk processes within each cycle. With the first two batches, for example, the continuous state vector of the observer is given by x^{c}=(V_{w}′, dₛ, s₀, R₀, G₁)^{T} where s₀, R₀, G₁ are the model parameters, whereas the discontinuous state vector, X^{d}, corresponds to the actual infeed rate, v.

In order to demonstrate the advantages of the multi-rate estimation, the performance of the observer was tested for two different measurement settings—one with in-process sensing of grinding power P only and the other with both in-process sensing of P and post-process inspection. Note the first measurement setting corresponds to those of existing observers in studies based solely on in-process sensors for discrete processes.

A system is observable if every state can be determined from the observation of available output variables over a finite time interval. A test of the observability for the given system shows that the grinding process is rendered unobservable when attempting to estimate both the model parameters and the state variables using only P signals. Feedback of intermittent post-process measurement of the part quality and tool condition using the estimation scheme of the present disclosure can overcome such limitations imposed by lack of in-process sensors.

Table V lists observer settings and parameter values used for the first two batches as well as those for the third batch without post-process measurement of radial wheel wear. Note the initial values of the model parameters of the observer were set according to their nominal values in Table IV.

TABLE V
Settings and parameters of the observers built for validation

| | | Batch | | | |
|---|---|---|---|---|---|
| | | 1, 2 | | 3 | |
| State vector | x^{c} | V_{w}′, dₛ, s₀, R₀, G₁ | | V_{w}′, s₀, R₀ | |
| | x^{d} | V | | v | |
| Measurement | In-Process | P | P | P | P |
| setting | Post- | — | Rₐ, dₛ, D_{w} | — | Rₐ, D_{w} |
| | process | | | | |
| Filter | Measurement | R_{i,k}^{f} = 10⁴ | Rᵢ = diag[10⁴ | R_{i,k}^{f} = 10⁴ | Rᵢ = diag[10⁴ 10⁻⁴ |
| parameters | noise | | 10⁻⁴ 10⁻⁶ 10⁻⁴] | | 10⁻⁴] |

| | | |
|---|---|---|
| Qᵢ | diag[100 10⁻⁶ 10⁻⁵ 10⁻³ | diag[100 10⁻⁵ 10⁻⁵ |
| | 1000 10⁻⁶] | 10⁻⁶] |
| Q_{i,k} | 10⁻⁴ × Qᵢ | 10⁻⁴ × Qᵢ |
| P₀ | 4 × Qᵢ | 4 × Qᵢ |

This section presents the performance of the proposed estimation scheme on three batches of grinding cycles. Before each batch starts, the grinding wheel was dressed according to the dressing parameters used for model building, i.e., a_{d}=25 μm and s_{d}=0.114 mm.

All grinding cycles in the first two batches were run under identical grinding parameters. Specifically, the nominal wheel speed and work speed were fixed at 31.6 m/s and 0.68 m/s, respectively, while the command infeed rate, u, was scheduled such that plunge grinding is performed in three distinct stages of roughing, finishing, and spark-out within 50.6 s (roughing: u=0.0106 mm/s for 0≦t≦27.6 s, finishing: u=0.0021 mm/s for 27.6≦t≦39.6 s, spark-out: u=0 mm/s for 39.6≦t≦50.6 s).

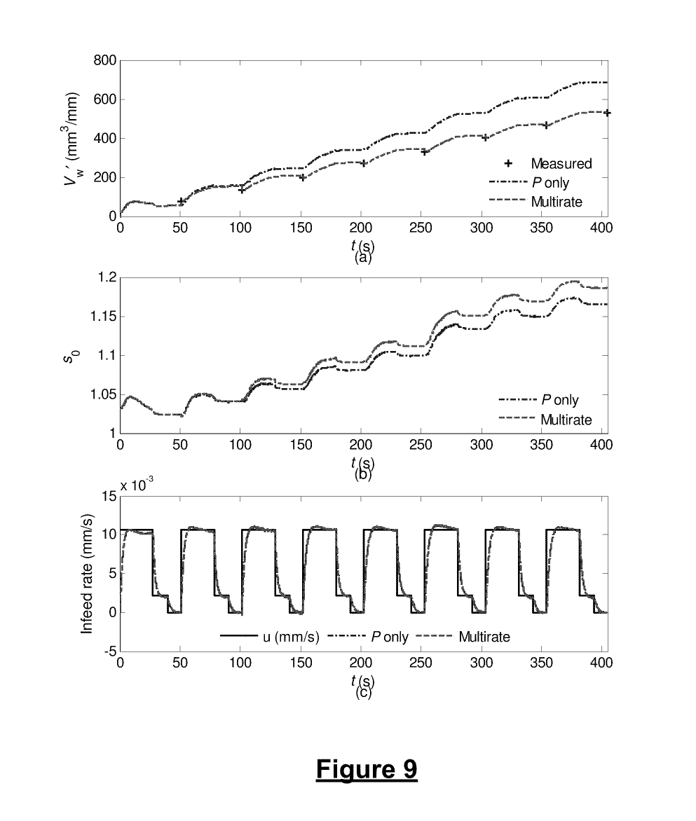

Results of estimation and in-process prediction with the first batch are shown in FIGS. 9-11. Note that idle times between cycles associated with unloading and loading parts and inspection are not shown for simplicity. FIG. 9 presents the results of estimating state variables V_{w}′ and v along with model parameter s₀, which is closely related to the two state variables according to the process models. FIG. 9(a) shows measured versus estimated accumulated metal removals. FIG. 9(b) shows estimated model parameter, sₒ. FIG. 9(c) shows command infeed rate u versus estimated actual infeed rates.

In FIG. 9(a), the plus sign represents the measured value of V_{w}′, which can be calculated based on the measured value of D_{w}, whereas the two non-solid lines show the estimates of V_{w}′ based on the two measurement settings. When the observer utilized only grinding power P while ignoring the post-process data, the estimated state variable V_{w}′ exhibited an offset from the measured value. Lack of the observability when relying only on the measurement of P can be explained by reviewing its model:

P=Kₛ(s₀+s₁V_{w}′^{δ})d_{w}ν (26)

Suppose an expectedly high grinding power P is measured due to a mismatch between the models and the actual process. The observer will have to increase the estimate of either V_{w}′ or v to account for the difference between the predicted P according to the models and the measured value of P. Since V_{w}′ is an integral of v over time, i.e., \dot{V}_{w}′=πd_{w}ν, any error in the estimated v will result in an increased offset in the estimated V_{w}′. It can be seen that measurement of P is not sufficient for estimating both V_{w}′ and v in the presence of model-process mismatch or disturbances.

In contrast, correcting the estimate of V_{w}′ at the end of each grinding cycle with the proposed multi-rate estimation scheme led to a better overall estimation. Moreover, since the model parameter, s₀, is simultaneously updated by the multi-rate sampling as shown in FIG. 9(b), the prediction by the process model improves requiring less drastic post-process corrections as the batch approaches its end in FIG. 9(a).

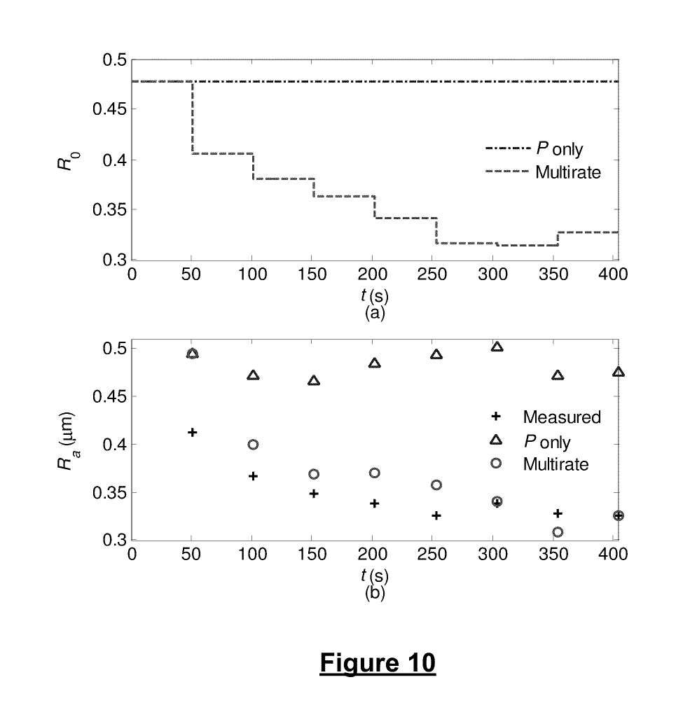

FIG. 10 shows the performance of the proposed scheme in estimating parameter R₀ in the output equation for the surface roughness, Rₐ, as well as in predicting Rₐ before each grinding cycle ends. FIG. 10(a) shows estimated model parameter, R₀. FIG. 10(b) shows a comparison of Rₐ and its a priori estimate, \hat{R}ₐ⁻, at the end of each cycle.

It is demonstrated here that intermittent post-process measurement of the part quality can reduce the model-process mismatch due to process variations as well as predict the part quality in real time. The two estimates of R₀ are shown in FIG. 10(a), and the prediction in FIG. 10(b) refers to an a priori estimate of surface roughness at the end of each grinding cycle before an a postriori update takes place based on measurement of the actual surface roughness. The parameter R₀ in the output equation for the surface roughness cannot be estimated without feedback of the surface roughness. In contrast, R₀ was updated at the end of each cycle with the multi-rate measurement setting as shown in FIG. 10(a), leading to a good agreement between the measured surface roughness and the prediction at the end of each cycle in FIG. 10(b).

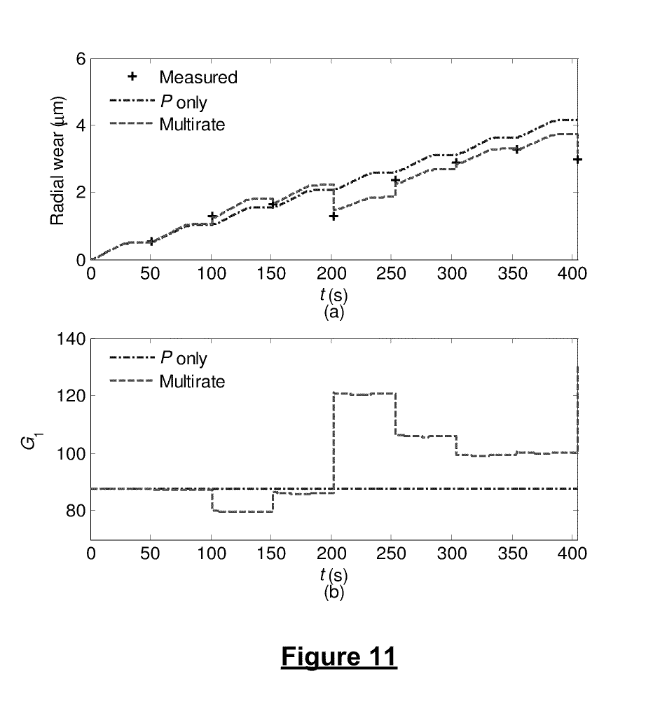

FIG. 11 compares the results based on the two measurement settings for estimating the wheel diameter. FIG. 11(a) shows measured versus estimated radial wheel wears. FIG. 11(b) shows estimated model parameter, G₁.

A real-time knowledge of the wheel diameter allows for tight control of the work-piece dimension, but in-process sensing of the wheel diameter is difficult due to the high rotation speed of the grinding wheel and its abrasive action. It is demonstrated here that the wheel diameter can be estimated in real time during a cycle run through simulation of the process model based on input variables and estimates of other state variables, while intermittently correcting the estimate based on postprocess measurement of its actual value. In FIG. 11(a), the estimated wheel wear based on on-line sensing alone exhibited an increasing offset from the measured value. In contrast, correcting the estimate of the wheel wear in the multi-rate measurement setting at the end of each grinding cycle led to a better overall estimation, although the estimates were noisy at times due to the high level of measurement noise. Moreover, updating the model parameter, G₁, improved real-time estimation of the wheel wear leading to overall decreasing post-process corrections with increasing cycle numbers.

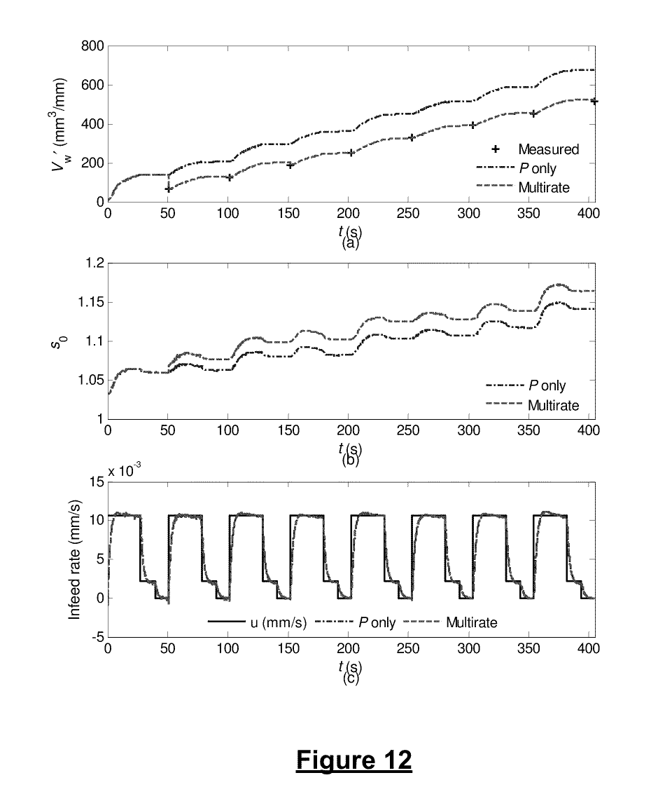

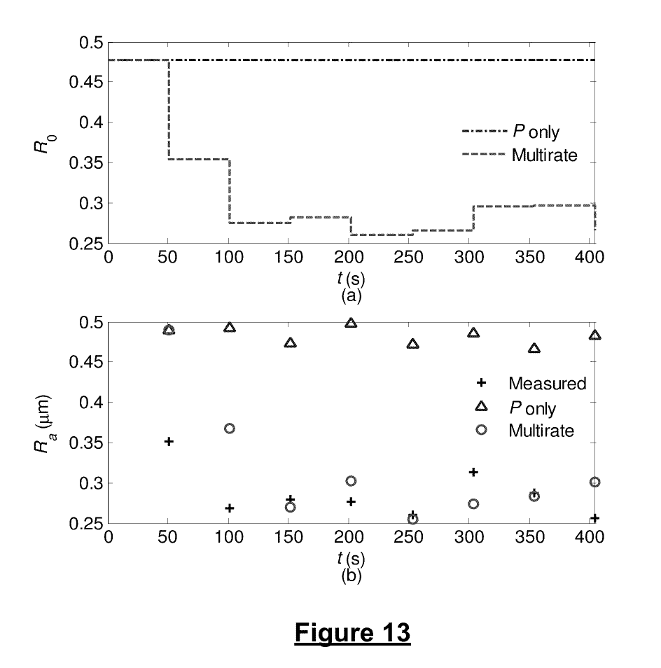

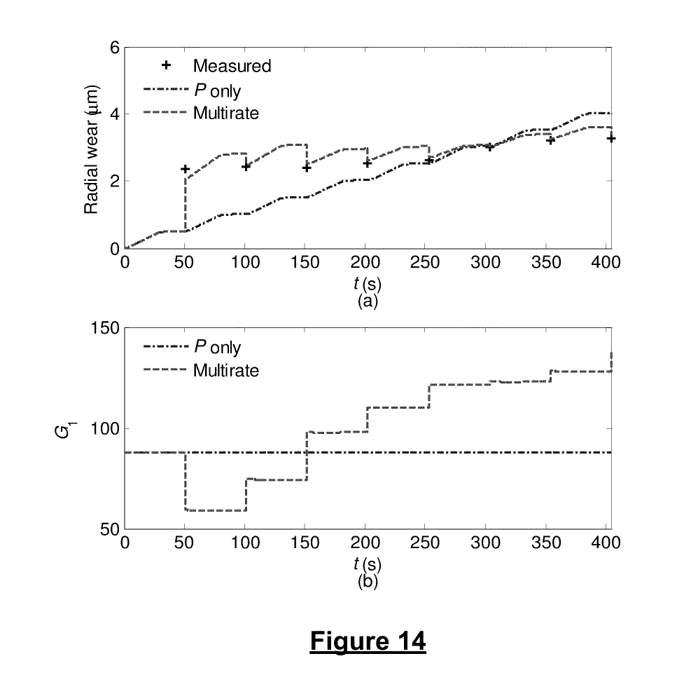

Results of estimation and in-process prediction with the second batch are shown in FIGS. 12-14. FIG. 12(a) shows measured versus estimated accumulated metal removals. FIG. 12(b) shows estimated model parameter, s₀. FIG. 12(c) shows command infeed rate u versus estimated actual infeed rates. FIG. 13(a) shows estimated model parameter, Rₒ. FIG. 13(b) shows a comparison of Rₐ and its a priori estimate, hₐ⁻, at the end of each cycle. FIG. 14(a) shows measured versus estimated radial wheel wears. FIG. 14(b) shows estimated model parameter, G₁.

Observations similar to those of the first batch can be made except for the evident batch-to-batch variations reaffirming the motive for simultaneous estimation of model parameters. For example, the converged value of model parameter R₀ for the second batch was around 0.27 as shown in FIG. 13(a) whereas that for the first batch was higher at 0.33.

The estimation scheme of the present disclosure was applied to another batch consisting of mixed grinding cycles in series. Three different grinding schedules, as listed in Table VI, were repeated in tandem, starting with schedule A, until 10 cycles were completed. The wheel speed and work speed were fixed at 31.5 m/s and 0.65 m/s, respectively. Note the grinding cycle based on schedule C is identical to those of the previous two batches.

TABLE VI
Grinding schedules adopted for the third batch

| | A | B | C |
|---|---|---|---|
| Roughing | u = 0.0106 mm/s | u = 0.0085 mm/s | u = 0.0106 mm/s |
| | for 27.6 s | for 30 s | for 27.6 s |
| Finishing | u = 0.0021 mm/s | u = 0.0042 mm/s | u = 0.0021 mm/s |
| | for 12 s | for 15 s | for 12 s |
| Spark-out | u = 0 mm/s | u = 0 mm/s | u = 0 mm/s |
| | for 5 s | for 11 s | for 11 s |
| Cycle time (s) | 44.6 | 56 | 50.6 |

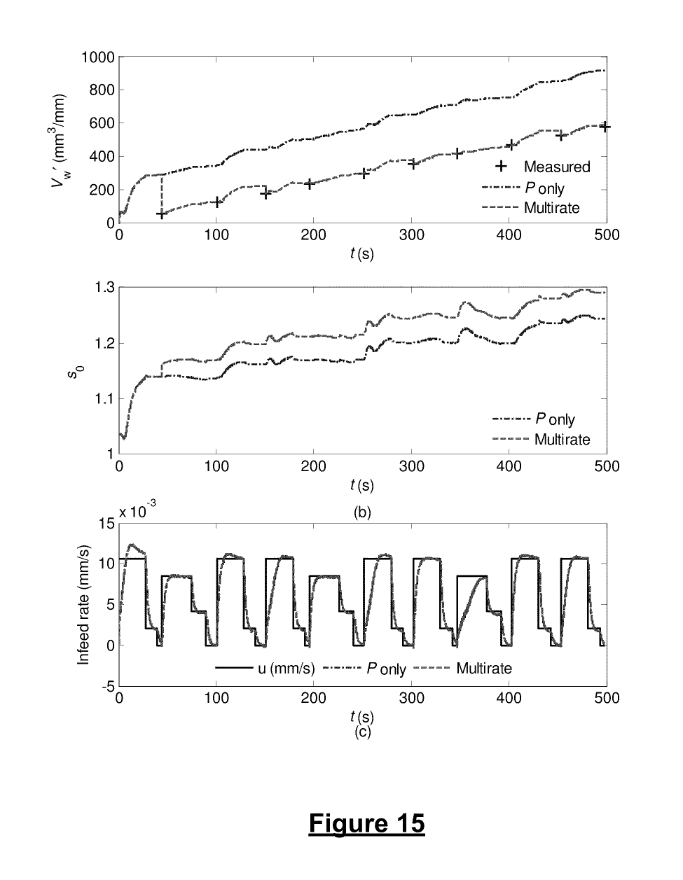

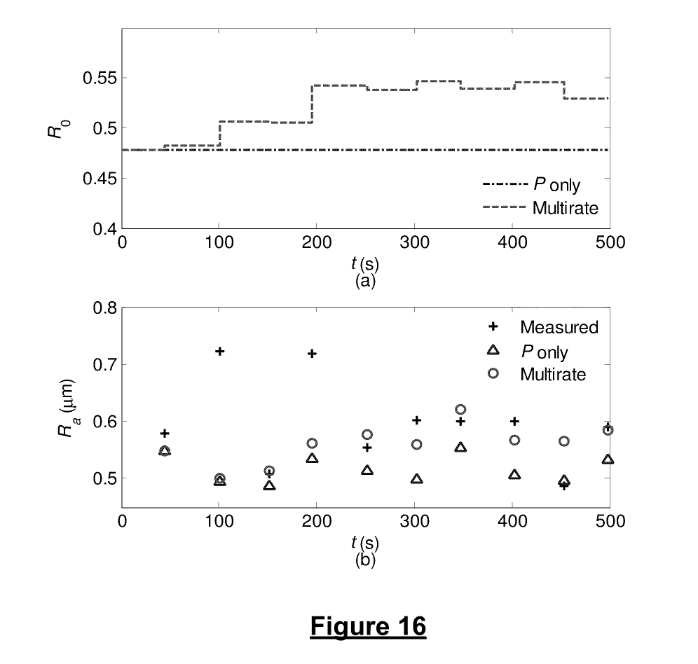

Results of estimation and in-process prediction are shown in FIGS. 15 and 16. FIG. 15(a) shows measured versus estimated accumulated metal removals. FIG. 15(b) shows estimated model parameter, sₒ. FIG. 15(c) shows command infeed rate u versus estimated actual infeed rates. FIG. 16(a) shows estimated model parameter, Rₒ. FIG. 16(b) shows a comparison of Rₐ and its a priori estimate, \hat{R}ₐ⁻, at the end of each cycle.

FIG. 15 shows that V_{w}′ was tracked well when its estimate was corrected by post-process data and s₀ was updated simultaneously. In contrast, the performance in predicting the surface roughness shown in FIG. 16(b) looks inferior to those under fixed input schedules in FIGS. 10(b) and 13(b). Evidently, the task of estimation and prediction is more demanding when the process is subject to varying input schedules than when it is run under a series of identical schedules. The condition of the grinding wheel such as its sharpness, for example, is known to vary over time and converge to a steady-state, which depends strongly on input grinding parameters. Therefore, increased fluctuations of model parameters such as R₀ can be expected when the process is run under varying input schedules. Nevertheless, the prediction performance based on the multi-rate sampling improved over time, notably after the fifth cycle, in FIG. 16(b).

The proposed algorithm integrates all the incoming data flows, including sensor signals and post-process measurement data, from a series of discrete process cycles with the aim of improved estimation. In the present disclosure, the multi-rate noise characteristics of discrete process cycles were represented in a state-space format, based on which the multi-rate Kalman filtering algorithm was derived. A new covariance matrix was introduced to naturally represent the cycle-to-cycle noise and disturbances and a set of intuitive guidelines for tuning of the filter parameters were issued. Results from implementation of the proposed observer on an actual grinding process demonstrated the applicability of the proposed multi-rate estimation scheme to practical problems in the manufacturing industry. When tested on a series of identical grinding cycles, i.e., an emulation of a typical batch production run, the implemented multi-rate observer tracked both states and model parameters well, while a traditional single-rate observer failed to do so.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

### APPENDICES

### Appendix A

Some of the output equations can be obtained by substituting the state and input variables into analytical models, as follows:

$$Grinding power \text{:} P = {K}_{s} ( {s}_{0} + {s}_{1} {x}_{1}^{δ} ) {x}_{2}$$

$$Roundness \text{:} r = {r}_{0} \frac{π {d}_{w} {x}_{2}}{{v}_{w}} + {r}_{m}$$

$$Surface roughness \text{:} {R}_{a} = [ {R}_{g} + ( {R}_{0} - {R}_{g } ) exp ( - \frac{{x}_{1}}{{V}_{0}^{′}} ) ] {( \frac{π {d}_{w} {x}_{2}}{{u}_{2}} )}^{γ}$$

The part-size reduction, D_{w} and wheel diameter, dₛ directly correspond—by their definitions—to two of the state variables, i.e. D_{w}=2x₁/πd_{w} and dₛ=x₃.

### Appendix B

The EKF operates in two distinct modes depending on the two sampling streams:

Within the ith cycle or when jε{0, 1, . . . , nᵢ−1}

An a priori update takes place according to the discretized model in (8), while the error covariance P is updated according to the following equation:

P⁻(i, j)=A(i, j−1)P(i, j−1)A^{T}(i, j−1)+Q (B.1)

where A is the Jacobian matrix of F_{d} with respect to X. Once an a priori estimate of the sensor output, ŷ_{f}⁻, is calculated from (9) with zero noise, the a posteriori update is performed based on its difference from the actual sensor output, y_{f}, as shown below:

\hat{X}(i, j)=\hat{X}⁻(i, j)+K_{f}[y_{f}(i, j)−ŷ_{f}⁻(i, j)] (B.2)

P(i, j)=[I−K_{f}C_{f}(i, j)]P⁻(i, j) (B.3)

where K_{f}=P⁻(i, j)C_{f}^{T}(i, j)[C_{f}(i, j)P⁻(i, j)C_{f}^{T}(i, j)+R_{f}]⁻¹ is the Kalman gain for the fast measurement, C_{f}(i, j) is the Jacobian matrix of H_{f} with respect to X, and R_{f} is the covariance of the fast measurement noise, ξ_{f}.

At the end of the ith cycle or when j=nᵢ

After the a priori state is estimated, an a priori estimate of the whole output, ŷ⁻ is calculated based on (10) with zero noise. Both the on-line sensor output and the off-line measurement data are used to update the state estimation as follows:

\hat{X}(i, nᵢ)=\hat{X}⁻(i, nᵢ)+K[y(i, nᵢ)−ŷ⁻(i, nᵢ] (B.4)

P(i, nᵢ)=[I−KC(i, nᵢ)]P⁻(i, nᵢ) (B.5)

where K=P⁻(i, nᵢ)C^{T}(i, nᵢ)[C(i, nᵢ)P⁻(i, nᵢ)C^{T}(i, nᵢ)+R]⁻¹ is the Kalman Gain and C(i, nᵢ) is the Jacobian matrix of H with respect to X, and R is the covariance of the measurement noise, ξ.

### Appendix C

Process models for the grinding power, surface roughness, part size reduction, and wheel wear are developed based on a series of experiments. A dynamic state-space model for the cylindrical plunge grinding process is derived from these process models.

### Appendix C.1

This section describes the procedure for obtaining process models for the grinding power, surface roughness, and wheel wear from experimental data. Consider a cylindrical plunge grinding process, in which a rotating cylindrical work-piece with a nominal diameter of d_{w} (m/s) and a surface velocity of v_{w} (m/s) is ground by a rotating grinding wheel with a nominal diameter of dₛ (mm) and a surface velocity of vₛ (m/s). The grinding wheel is fed into the work-piece at a command infeed rate, u. Note, due to the mechanical stiffness and sharpness of the wheel surface, there exists a dynamic delay of the actual infeed rate, v, in response to the command infeed rate, u, which can be described by a first-order dynamic system:

$$u - v = τ \frac{d v}{d t} \qquad ( C .1 )$$

where τ is the time constant (s) whose value is dependent on the machine-wheel-workpiece stiffness, dullness of the wheel, and wheel speed according to the following equation:

$$τ = \frac{D π {d}_{w} {b}_{s}}{{kv}_{s}} \qquad ( C .2 )$$

where D is the dullness of the wheel, bₛ is the wheel width (mm), and k is the system stiffness (N/mm). The wheel dullness is known to increase monotonously with an increase in the accumulated metal removal per unit wheel width after dressing, V_{w}′ (mm³/mm), in general for aluminum oxide wheels as follows:

D=D₀+D₁V_{w}′_{δ} (C.3)

where V_{w}′ is the accumulated amount of metal removed from the work-piece after wheel dressing or reconditioning (mm³/mm) while D₀, D₁ and δ are constants. A simple model of the grinding power, P (W) for a moderate range of wheel speeds can be represented as a linear function of the metal removal rate as follows:

P=μDπd_{w}bₛv (C.4)

where μ is the friction coefficient. Combining Eqs. (C.3) and (C.4) yields the grinding power as a function of v and Vw′ as follows:

P=Kₛ(s₀+s₁V_{w}′^{δ})d_{w}ν (C.5)

where Kₛ=kμ, s₀=Dₒπbₛ/k and s₁=D₁πbₛ/k .

A straightforward way of determining the model coefficients, Kₛ, s₀, s₁ and δ would be to directly fit a set of measurement tuples (P, V_{w}′, v) to Eq. (C.5). However, due to the difficulty in measuring the actual infeed rate, v, an indirect approach was adopted as described here. In order to determine Kₛ, Eqs. (C.2) and (C.4) were combined as follows:

P=Kₛ(τvₛv) (C.6)

It can be seen that P is proportional to τvₛv with a constant of proportionality equal to Kₛ. Since P is proportional to v when other parameters are fixed as shown in Eq. (C.5), the response of P to a step input u shows characteristics of a first-order system with a time constant of τ according to Eq. (C.1). Therefore, τ as well as the steady-state values of P and v, assuming v equals u at a steady state, were obtained from a step response of P for a known input u. In this manner, 52 pairs of τvₛv and P were obtained from 52 different step responses under varying experimental conditions in the following range:

0.0021≦u≦0.0106 (mm/sec)

0≦V_{w}′≦1060 (mm³/mm)

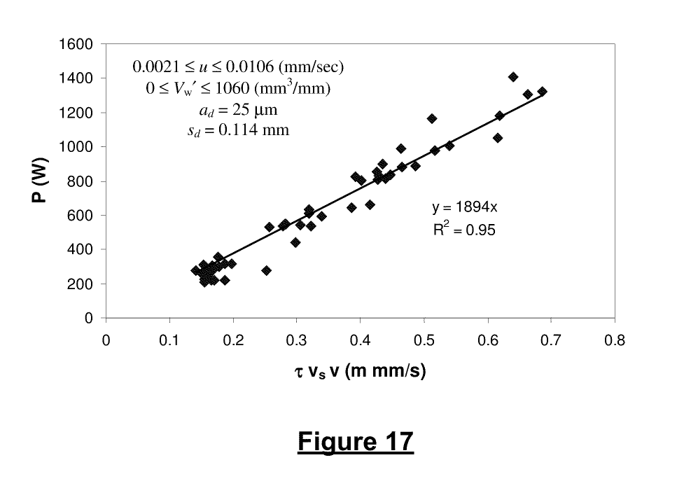

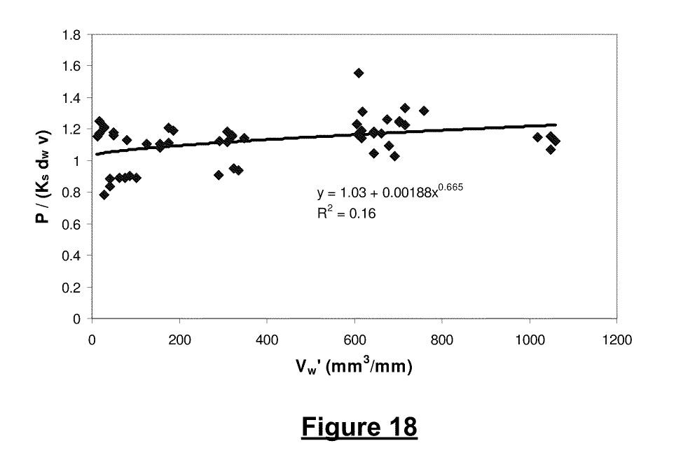

Note that the dressing parameters were fixed at a_{d}=25 um and s_{d}=0.114 mm. FIG. 17 plots the 52 pairs from which Kₛ is given by 1894 N/mm. Using the Kₛ thus obtained, FIG. 18 was plotted based on the 52 step responses after modifying Eq. (C.5) as follows:

$$\frac{P}{{K}_{s} {d}_{w} v} = {s}_{0} + {s}_{1} {v}_{w}^{′δ} \qquad ( C .7 )$$

Through a nonlinear regression analysis of the data in Fig. C.2, s₀, s₁ and δ were determined to be 1.03, 0.00188, and 0.665, respectively.

The surface roughness (μm) is known to be dependent on the dressing parameters, the wheel wear and the equivalent chip thickness, h_{eq} (μm), which is defined by the following equation:

$${h}_{eq } = \frac{π {d}_{w} v}{{v}_{s}} \qquad ( C .8 )$$

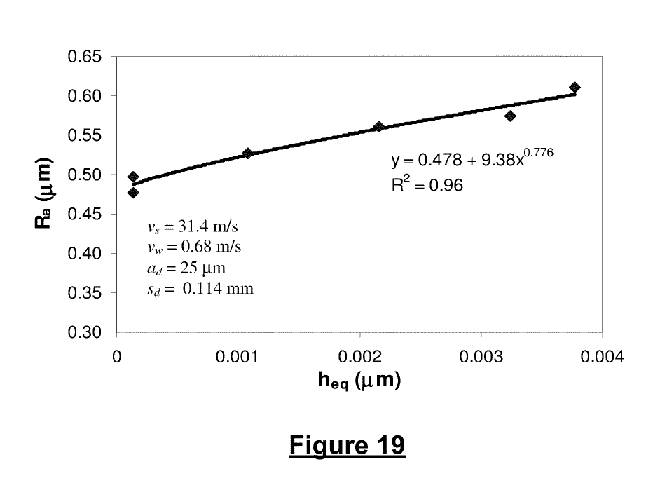

FIG. 19 plots Rₐ for varying h_{eq} immediately after a wheel-dressing operation under fixed dressing parameters. It was determined that the following empirical model would be appropriate for describing the relationship between Rₐ and h_{eq} for fixed dressing parameters:

Rₐ=R₀+R₁h_{eq}^{γ} (C.9)

where R₀, R₁ and γ are model parameters whose nominal values after curve-fitting are given by 0.478, 9.38, and 0.776, respectively. However, it should be noted the actual surface roughness can be quite different from the prediction of this model, notably when the wheel is worn. Moreover, even the surface roughness after the wheel is dressed under identical parameters, could vary widely from trial to trial due to uncontrolled variations such as those in the condition of the dressing tool. Therefore, there is a strong need for continuously updating the surface roughness model based on feedback from the process.

The grinding ratio (G-ratio) is defined as the ratio between the volumetric removal rate of the metal and that of the wheel. In the cylindrical grinding process, the G-ratio, G is given as:

$$G = \frac{{d}_{w} v}{{s}_{s 0} w} \qquad ( C .10 )$$

where dₛ₀ is the initial wheel diameter after dressing (mm) and w is radial wear rate of the wheel (mm/s). The equivalent chip thickness, h_{eq}, is a major factor for the G-ratio as shown in the following model:

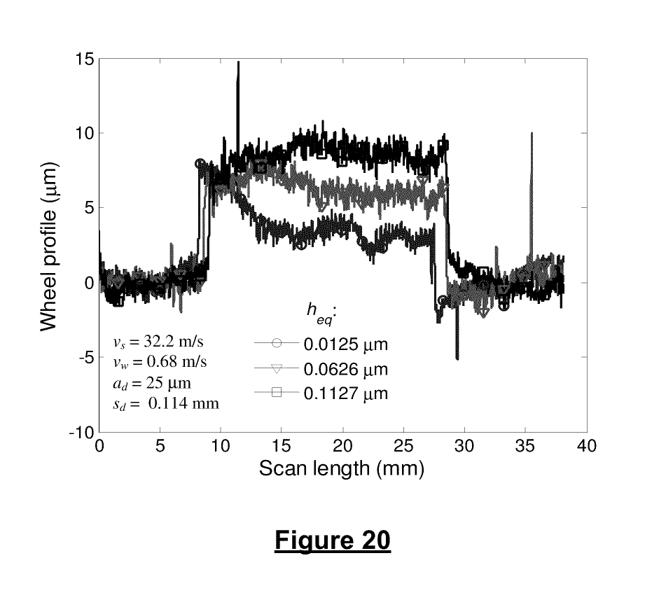

G=G₁h_{eq}^{-g} (C.11)

where G₁ and g are the model parameters. In order to determine the nominal values of the model parameters, the amount of wheel wear was measured after removing metal by 602 mm³ under various h_{eq} values. Since the workpiece width is smaller than that of the wheel, the contact surface on the wheel is slightly indented after each removal. The depth of indentation was obtained by first making a replica of the wheel using a steel blade and by scanning the profile of the replica using a laser triangulation sensor. FIG. 20 shows measured wheel profiles for three different values of h_{eq}.

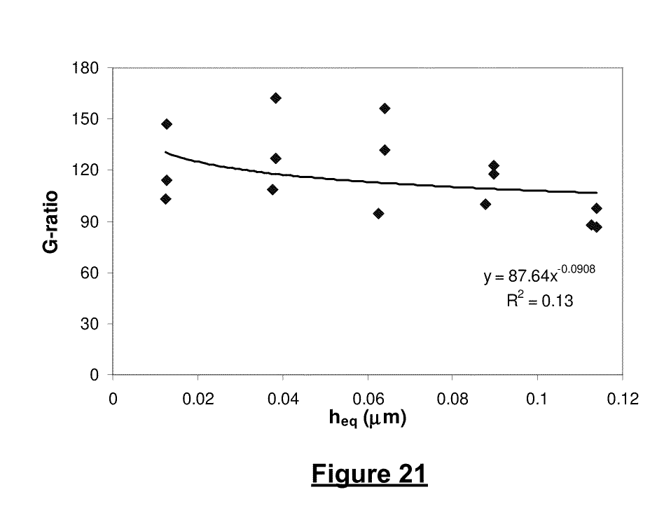

Assuming the G-ratio remains constant over time for a given chip thickness, the G-ratio was obtained from each profile by calculating the ratio between the accumulated metal removal in the amount of 602 mm³ and the volumetric wheel wear as follows:

$$G = \frac{{V}_{w}^{′}}{π {d}_{s 0} Δ {r}_{s}} \qquad ( C .12 )$$

where Δrₛ is the depth of indentation on the wheel. FIG. 21 shows variation of G-ratio for varying h_{eq}, based on which nominal values of G₁ and g are given by 87.6 and 0.0908, respectively, via curve-fitting.

### Appendix C.2

This section describes how a dynamic state-space model can be derived for the cylindrical plunge grinding process based on its process models in Section C.1. Three dynamic relationships can be identified from the developed process models. The first relationship is the dynamic delay of the actual infeed rate, v, in response to the command infeed rate, u, in Eq. (C.1). The accumulated metal removal, by its definition, is related to infeed rate v by another first-order differential equation:

\dot{V}_{w}′=πd_{w}v (C.13)

Moreover, the wheel diameter, dₛ (mm) as a function of time can be represented by the following equation by combining Eqs. (C.8), (C.10), (C.11) and \dot{d}ₛ=−2w:

$${\dot{d}}_{s} = - \frac{2 {π}^{g} {d}_{w}^{1 + g}}{{d}_{{s}_{0}} {G}_{1}} {v}_{s}^{- g} {v}^{1 + g} \qquad ( C .14 )$$

where dₛ_{₀} is the initial wheel diameter (mm).

Via discretization of Eqs. (C.1), (C.13), and (C.14), a nonlinear state-space model in the form of xₖ₊₁=f(xₖ,uₖ) can be derived where x=(x₁, x₂, x₃)^{T}=(V_{w}′, dₛ, v)^{T}ε [symbol] ³ and u=(u₁, u₂)^{T}=(u, vₛ)^{T}ε [symbol] ². It should be noted that, among the state variables, the actual feed rate, v, is partially discontinuous over a series of machining cycles since it is reset to 0 at the start of each cycle. On the other hand, the accumulated removal, V_{w}′ by its definition, as well as the wheel diameter, dₛ, should be continuous across cycles. It should be noted that both V_{w}′ (tool use) and dₛ (tool size) represent the tool condition. Defining a continuous state vector x^{c}=(V_{w}′, dₛ)^{T} and a discontinuous state vector x^{d}=v where x=[x^{c}; x^{d}], it can be seen that a series of grinding cycles is a system with partially continuous states.

It can be seen that many output variables of the grinding process, including those in Section C.1, are nonlinear functions of x and u, i.e., y=h(x,u) when y=(P, Rₐ, D_{w}, dₛ)^{T} as follows:

$$\begin{matrix}P = {K}_{s} ( {s}_{0} + {s}_{1} {x}_{1}^{δ} ) {d}_{w} {x}_{3} & ( C .15 ) \\ {R}_{a} = {R}_{0} + {{R}_{1} ( \frac{π {d}_{w} {x}_{3}}{{u}_{2}} )}^{γ} & ( C .16 ) \\ {D}_{w} = \frac{2 {x}_{1}}{π {d}_{w}} & ( C .17 ) \\ {d}_{s} = {x}_{2} & ( C .18 )\end{matrix}$$

where D_{w} is the accumulated reduction in part diameter (mm).

What is claimed is:

1. A method for estimating a process variable associated with a series of operations of a manufacturing process, comprising:
deriving a model that represents a given operation of the manufacturing process, the operation having first, second, and third process variables associated therewith, where the model includes the first, second, and third process variables, and where variations in the first and second process variables during each of the operations are substantially immeasurable;
measuring the first process variable after a first one of the operations;
measuring the third process variable during a second one of the operations using a sensing device;
estimating at least one of the first and second process variables during the second one of the operations using the measured first process variable, the measured third process variable, and the model; and
controlling the second operation based on the at least one of the first and second estimated process variables.

2. The method of claim 1, further comprising measuring the third process variable at predetermined intervals during each of the operations and measuring the first process variable between each of the operations.

3. The method of claim 2, further comprising estimating the at least one of the first and second process variables during each of the operations using a state observer.

4. The method of claim 3, further comprising estimating the at least one of the first and second process variables using a Kalman filter.

5. The method of claim 1, wherein the model is further defined as a state space model.

6. The method of claim 5, wherein the first, second, and third process variables are represented as functions of state variables of the state space model, and wherein an output vector of the state space model includes the measured third process variable and the measured first process variable.

7. The method of claim 1, wherein the first and second operations are performed on first and second parts, respectively, using a machine tool.

8. The method of claim 7, wherein the model includes a parameter of the machine tool, and wherein the model represents variations in the parameter of the machine tool between the first and second operations.

9. The method of claim 8, further comprising:
representing the variations in the parameter using a noise variable of the model;
estimating the at least one of the first and second process variables using an estimation algorithm that includes gains;
modifying one of the gains at the end of the first operation using the noise variable of the model; and
using the modified one of the gains during the second operation.

10. The method of claim 7, wherein the model includes a parameter associated with the first and second parts, and wherein the model represents variations in the parameter between the first and second parts.

11. The method of claim 10, further comprising:
representing the variations in the parameter using a noise variable of the model;
estimating the at least one of the first and second process variables using an estimation algorithm that includes gains;
modifying one of the gains at the end of the first operation using the noise variable of the model;
determining the value of the parameter associated with the second part based on the value of the parameter associated with the first part; and
using the parameter associated with the second part and the modified one of the gains during the second operation.

12. The method of claim 1, wherein the estimations of the at least one of the first and second process variables indicate at least one of a measurement of a part being produced during the second operation and a measurement of a tool used to produce the part during the second operation.

13. The method of claim 1, wherein the measured first process variable includes measurements corresponding to at least one of a part produced during the first operation and a tool used to produce the part during the first operation.

14. A system for estimating a process variable associated with a series of operations of a machine tool, comprising:
an estimation module that includes a model that represents a given operation of the machine tool, the given operation having first, second, and third process variables associated therewith, where the model includes the first, second, and third process variables, and where variations in the first and second process variables are substantially immeasurable during the given operation;
a post-process acquisition module that determines the first process variable after a first one of the operations; and
an in-process acquisition module that determines the third process variable during a second one of the operations based on signals received from a sensing device,
wherein the estimation module estimates at least one of the first and second process variables during the second one of the operations using the determined first process variable, the determined third process variable, and the model.

15. The system of claim 14, further comprising an actuation module that actuates the machine tool to perform the second one of the operations based on the at least one of the first and second estimated process variables.

16. The system of claim 15, wherein the first process variable represents a measurement of at least one of a component of the machine tool and a part produced during the first one of the operations.

17. The system of claim 16, wherein the machine tool includes a grinding tool, and wherein the first process variable represents at least one of a diameter of a grinding wheel of the machine tool, a residual stress associated with the part, a roundness of the part, and a surface roughness of the part.

18. The system of claim 15, wherein the signals received from the sensing device indicate an operating condition of the machine tool during the second one of the operations.

19. The system of claim 18, wherein the machine tool includes a grinding tool, and wherein the signals received from the sensing device indicate at least one of a grinding power of the machine tool and a reduction in the size of the part.

20. A method for estimating a process variable associated with a series of grinding operations of a grinding machine tool during a manufacturing process, comprising:
deriving a state space model that represents a given grinding operation of the manufacturing process, the grinding operation having first, second, and third process variables associated therewith, where the state space model includes the first, second, and third process variables, and where variations in the first and second process variables during each of the grinding operations are substantially immeasurable;
measuring the first process variable after a first one of the grinding operations, wherein the measured first process variable represents a measurement of at least one of a component of the grinding machine tool and a part produced during the first one of the grinding operations;
measuring the third process variable during a second one of the grinding operations using a sensing device that indicates an operating condition of the grinding machine tool during the second one of the grinding operations;
estimating at least one of the first and second process variables during the second one of the operations using the measured first process variable, the measured third process variable, and the state space model; and
controlling the second one of the grinding operations based on the at least one of the first and second estimated process variables.
